(19) United States
(12) Patent Application Publication
(10) Pub. No.: US 2022/0074162 A1
(43) Pub. Date: Mar. 10, 2022

(54) DEVICE FOR BLOCKING A PASSAGE

(71) Applicant: LIBERVIT, Perpignan (FR)

(72) Inventor: Yvan CARDONA, Bompas (FR)

(21) Appl. No.: 17/416,740

(22) PCT Filed: Dec. 11, 2019
(86) PCT No.: PCT/FR2019/053013

§ 371 Date: Jun. 21, 2021

(30) Foreign Application Priority Data
Dec. 21, 2018 (FR) 1874003

(51) Int. Cl. E02D 29/12

(52) U.S. Cl. CPC E02D 29/127

(57) ABSTRACT

A removable obturation device is provided for transversely obstructing a passage delimited by a cylindrical side wall wherein it includes: a) a support and blocking element having a central block supporting a plurality of arms disposed perpendicularly in a radial position with respect to the longitudinal axis of the block and of the side wall, each arm having an extensible rod including a pad intended to be blocked against one the side wall, and b) at least one complementary obturation element extending in a radial transverse plane perpendicular to the longitudinal axis, at least partly in or opposite the space between the arms so as to prevent an individual from falling through the passage. The obstruction element is preferably removably fastened to the support and blocking element.

### TECHNICAL FIELD

The present invention relates to a device for temporarily obstructing a passage, in particular a well for accessing an underground pipe of an underground sewerage network intended to collect and discharge the different waters, whether natural such as run-off water and rainwater or produced by human activity such as wash water, drainage water or waste water (household waste water and black water; gray water), called a manhole, in addition to or as temporary replacement for a manhole cover constituting the lid of the manhole. It has primarily utility and safety purposes: it is about limiting the access to the underground sewerage networks only to professionals (sewer men) and avoiding the accidents on public ways. In case of theft of a manhole cover or of flooding-related displacement or loss, the obturation device according to the invention allows preventing pedestrians from falling during the time of replacement of the cover (frequent problem sometimes causing the death of the victims).

More particularly, the object of the present invention is to provide a device for obturating a manhole which is installed to prevent heavy floods or precipitation with the risk of sewerage overflows or run-off water or flooding, which allows water discharge through the device while preventing pedestrians from falling into the manhole. Another aim is to provide a device provided with fastening means strong enough to withstand the weight of a pedestrian walking over it without separating it from the vertical bearing surfaces and to withstand the weight of a cast-iron manhole cover if the device is placed on the underside thereof. Another aim is to provide a device that can be easily installed in series from a single blocking tool on site.

The manhole covers are most often round, with a diameter slightly larger than that of the hole because it is the simplest shape to produce for preventing the cover from falling to the bottom of the hole, which constitutes a safety factor for sewer men working underground. A square cover, for example, could fall if it was introduced through the diagonal of a square hole. A round shape is also easier to handle for workmen or sewer men, since it is possible to roll it and replace it without having to align it, at least for the covers that can be completely removed, some having a retaining tab and only pivot. In addition, for the hole, the cylindrical shape is the most solid and the simplest shape to avoid its compression by the pressure of the ground surrounding it. The cover has therefore the same shape as the hole.

### PRIOR ART

It is known in WO 2010/125270, in the name of the Applicant, an autonomous protection device that allows temporarily obstructing a passage such as a corridor, a door or a window, characterized in that it comprises at least one longitudinally extensible bar, preferably a telescopic bar, operable in extension by a jack, said bar being able to be removably blocked in extension between two wall surfaces delimiting said passage called blocking surfaces, said extensible bar supporting a plurality of obstruction elements to form a protective shield making an obstruction at the level of said passage, preferably said obstruction element(s) being removably fastened thereto. This device allows temporarily obstructing a passage such as a bay or a corridor in order to prevent or delay the crossing of this passage by consenting or non-consenting persons and/or to prevent the projection of objects through said device, in particular from outside to inside or from inside to outside when the device is laid against a door or window. More particularly, this type of device aims at preventing a suicidal defenestration during the arrest of madmen, but also aims at allowing channeling people by temporarily obstructing some passages, for example corridors, during demonstrations or crowd movement in public or private places.

The device of WO 2010/125270 on the one hand is not suitable for the obturation of a cylindrical, in particular circular, passage in a horizontal plane and on the other hand does not meet the specific aims of the present invention in terms of partial obturation allowing the discharge of water without authorizing the passage of pedestrians with a fastening strong enough to withstand the weight of a pedestrian walking over it and the weight of a cast-iron manhole cover if the device is placed on the underside thereof. Finally, it does not allow an easily removable installation in series.

To do so, the present invention provides a removable obturation device for transversely obstructing a passage delimited by a cylindrical side wall characterized in that it comprises:
a) a support and blocking element comprising a central block comprising a longitudinal axis (ZZ′) intended to be positioned in the longitudinal axis of said side wall of said passage, supporting a plurality of arms disposed perpendicularly in a radial position (XX′, YY′) with respect to said longitudinal axis (ZZ′), preferably the different arms being disposed symmetrically with respect to said longitudinal axis (ZZ′); each arm comprising an extensible rod comprising at its free end a pad, preferably fastened in a reversible manner to the end of said extensible rod, able to be blocked in abutment against one said side wall by extension of said extensible rod, and
b) at least one complementary obturation element extending in a transverse plane (XX′, YY′) perpendicular to said longitudinal axis (ZZ′) of said passage, at least partly in or opposite the space between said arms so as to prevent an individual from falling through said passage, said obstruction element being preferably removably fastened to said support and blocking element.

This system is possibly intended for several uses. In case of flooding, it is installed to prevent heavy floods or precipitation. In case of theft of a manhole cover, it allows preventing pedestrians from falling during the time of replacement of the cover (a frequent problem in India, sometimes causing the death of victims). In the event of a terrorist attack or perimeter lock down, the system can be used to allow security personnel, such as the police to prohibit the entry to or the exit from undergrounds.

Preferably, the device according to the invention further comprises a removable actuation element able to cooperate with said central block to actuate in extension or retraction said extensible rods of said arms simultaneously, said actuation element preferably comprising first reversible fastening means on said support and blocking element, preferably at said central block.

The axis ZZ′ is called longitudinal axis in that it extends in the longitudinal direction of said passage.

More particularly, in the device according to the invention:

said actuation element comprises a geared motor able to actuate in rotation on itself along its longitudinal axis (ZZ′) a shaft called motor shaft, and
said support and blocking element comprises:

a1) said arms each comprising one said drive shaft disposed in one said longitudinal direction in a perpendicular radial plane (XX′, YY′) with respect to said longitudinal axis (ZZ′) of said central block, each said drive shaft being able to be driven in rotation on itself along its radial longitudinal axis (XX′, YY′) and able to cooperate with one said extensible rod in coaxial translation by helical link such that said rotation on itself in either direction of said drive shaft causes the translation of said extensible rod in extension or respectively in retraction in one said radial direction (XX′, YY′), and

a2) one said central block comprising a shaft called input shaft (2b) disposed along the longitudinal axis (ZZ′) of said central block and able to be actuated in rotation on itself with respect to its longitudinal axis (ZZ′) when it cooperates with said motor shaft of said actuation element, and an angle transmission device comprising bevel gears able to cooperate with each other at the ends of said input shaft and said drive shafts so that the rotation on itself along its longitudinal axis (ZZ′) of said input shaft simultaneously causes the rotations on themselves of said drive shafts along their axes in their said radial directions (XX′, YY′).

More particularly, in the device according to the invention, said helical link is of the screw-nut type, said drive shaft comprising an external helical threading forming a screw cooperating with a tubular rod at least one end portion of which forms a nut engaged on the threading of the threaded screw formed by said drive shaft, said nut being prevented from following said rotation of said drive shaft and said tubular rod being guided in said translation by a guide pin of said nut due to the fact that said guide pin cooperates with a rectilinear inner slot of a guide and protection cylinder inside which said drive shaft and one end portion at least of said tubular rod extend coaxially, the free end of the rod comprising said pad always remaining outside said guide and protection cylinder.

Said guide and protection cylinder also acts as a protection for the rod and drive shaft assembly in a helical link.

More particularly, the device according to the invention comprises a single obturation element extending above said arms, able to be removably fastened to said support and blocking element preferably at said central block.

More particularly, said obturation element comprises a hoop linked to a central hub by spokes, said central hub of said hoop being able to be removably fastened to said support and blocking element around said central block so that said spokes of the hoop extend between said arms, preferably along the bisectors of the angles between said arms.

More particularly, said support and blocking element comprises four said arms disposed in a cross at 90° around the central block.

In one variant, said obturation element comprises or cooperates with threads or rubber parts for smoothing a fall between said arms.

In another variant, said obturation element comprises spike elements to deter pedestrian from passing through said passage.

Still more particularly, said actuation element comprises a handwheel-shaped gripping element around said geared motor to which it is fastened.

Still more particularly, said actuation element comprises first reversible fastening means on said obturation element, preferably at a central hub of said hoop-shaped obturation element, the latter comprising second reversible fastening means on said support and blocking element, preferably at said central block.

It is understood that in this embodiment, said actuation element is fastened in a reversible manner on said support and fastening element by means of said obturation element before or after its fastening on said support and blocking element.

Still more particularly, said actuation element comprises a handwheel-shaped gripping element around said geared motor to which it is fastened, said handwheel comprising first reversible locking means allowing the blocking of the reversible fastening of said actuation element on said obturation element, by a movement of relative axial rotation about said longitudinal axis (ZZ′) of a magnet ring rotating with respect to said handwheel and on the underside of said handwheel, at least one magnet of said ring being able to cooperate with respectively at least a first metal elastic locking pin in a hole of said obturation element, said first locking pin being able to leave said hole attracted against said magnet, preferably by means of a first spring, when the positioning of said actuation element with respect to said obturation element and the rotation of said ring places said magnet opposite the first elastic locking pin of said obturation element, preferably opposite a first elastic locking pin in a hole at a central hub of said hoop-shaped obturation element.

Still more particularly, said obturation element comprises second reversible locking means allowing a blocking of the reversible fastening on said support and blocking element of the assembly of said actuation element fastened to said obturation element, by movements of relative axial rotation and translation with respect to said support and fastening element of the assembly of said actuation element fastened to said obturation element, along and respectively about said longitudinal axis (ZZ′).

These movements of relative axial rotation and translation with respect to said support and fastening element of the assembly of said actuation element fastened to said obturation element, ensure that said actuation element remains fastened to said obturation element.

Still more particularly, said hoop-shaped obturation element and said second reversible locking means comprise:

at a central hub of said hoop-shaped obturation element, at least a second locking pin and a second spring in a cylindrical recess within said central means of the hoop, and on the outer wall of said central block, at least one locking slot comprising a first vertical portion along the longitudinal direction (ZZ′) of said block, a second circular-arc portion on the periphery of said block and a third vertical portion, said second circular-arc portion forming the junction of the lower ends of said first and third vertical portions, said first vertical portion being open at its upper end and said third vertical portion being closed at its upper end,

so that said second reversible locking means are able to be actuated in locking by:

a first downward vertical translational movement of the assembly of said actuation element fastened to said obturation element with respect to said central block and coaxially therewith along its longitudinal axis (ZZ′), said second locking pin thus being able to be guided in translation in said first vertical slot portion up to its lower end by compressing said second spring in doing so,

a second rotational movement of the assembly of said actuation element fastened to said obturation element with respect to said central block, said second locking pin thus being able to be guided in rotation in said second circular slot portion up to the lower end of said third vertical slot portion, keeping said second spring compressed, and

a third upward vertical translational movement of the assembly of said actuation element fastened to said obturation element with respect to said central block and coaxially therewith along its longitudinal axis (ZZ′), said second locking pin thus being able to be guided in translation in said third vertical slot portion up to its upper end due to the extension of said second spring.

The present invention also provides a method for setting up an obturation device according to the invention in order to transversely obstruct a passage delimited by a cylindrical side wall characterized in that it comprises the steps of:

a) positioning the device according to the invention in said passage with the extensible rods of said arms in the retracted position, said arms being disposed in a perpendicular radial plane (XX′, YY′) with respect to said longitudinal axis (ZZ′) of said central block itself disposed coaxially with the axis of said passage, and

b) actuating, by means of one said actuation element, said arms to block said pads in abutment against the cylindrical wall of said passage by extension of said extensible rods, said actuation element cooperating with said central block to actuate in extension said extensible rods of said arms simultaneously.

Still more particularly, the method for setting up an obturation device according to the invention comprises the additional steps of:

a) positioning said device according to the invention in said passage with the extensible rod of said arms in the retracted position, using a handwheel-shaped gripping element fastened around a geared motor of said removable actuation element, and

b) actuating said arms to block said pads in abutment against the cylindrical wall of said passage by extension of said extensible rods using said geared motor of said actuation element, and

c) removing said removable actuation element to let in the passage only the assembly of said support and blocking element and said obturation element.

Still more particularly, the method comprises the preliminary steps of:

a1) fastening on said obturation element one said actuation element comprising a handwheel-shaped gripping element, then

a2) fastening the assembly of said actuation element assembled with said obturation element on said central block of said support and blocking element.

By doing so, said handwheel-shaped gripping element facilitates the set-up of said obturation element on said support and blocking element, then facilitates the set-up of the obturation device according to the invention 1 with its 3 elements thus assembled in the appropriate position in said passage, then facilitates the removal of said actuation element to use it for the mounting and the set-up of another obturation device according to the invention in another passage.

### BRIEF DESCRIPTION OF THE DRAWINGS

Other characteristics and advantages of the present invention will emerge more clearly upon reading the following description, given in an illustrative and non-limiting manner, with reference to the appended drawings in which:

FIG. 1 represents a perspective view of an obturation device according to the invention with one said support and blocking element 2 supporting an obturation element 6 and an actuation element 10.

FIG. 2A represents a first variant of an obturation device according to the invention placed in a manhole 20 with a cylindrical vertical underground wall having a circular section 20a, with one said support and blocking element 2 supporting an obturation element 6.

FIG. 2B represents a second variant of an obturation device according to the invention placed in a manhole 20 with a vertical cylindrical underground wall having a square section 20b, with one said support and blocking element 2 supporting an obturation element 6 and an actuation element 10.

FIG. 3A represents a perspective view of said support and blocking element 2 of an obturation device according to the invention.

FIG. 3B represents a top view of one said support and blocking element 2 of an obturation device according to the invention.

FIG. 3C represents an axial vertical sectional view along XX′ of one said support and blocking element 2 of an obturation device according to the invention with the retracted rod 3b.

FIG. 3D represents an axial vertical sectional view along XX′ of one said support and blocking element 2 of an obturation device according to the invention with the rod 3b in extension.

FIG. 4 represents a perspective view of the cylindrical walls 2a1 and 2a2 delimiting an empty space 2a3 of a central block 2a devoid of the input shaft 2b of one said support and blocking element 2.

FIG. 4A represents an axial vertical sectional view along XX′ showing the detail of the helical link of the drive shaft 3a and of the extensible rod 3b of an arm 3 of one said support and blocking element 2 of an obturation device according to the invention.

FIG. 4B represents an axial vertical sectional view along XX′ showing the detail of the reversible link of the end of the extensible rod 3a with a pad 4 of one said support and blocking element 2 of an obturation device according to the invention.

FIG. 5A represents a perspective view of an actuation element 10 with geared motor 11 and handwheel 12 with a magnet ring 9 on the underside.

FIG. 5B represents an axial vertical sectional view along ZZ′ of an actuation element 10 with geared motor 11 and handwheel 12 with a magnet ring 9 on the underside.

FIG. 6A represents a perspective view of a hoop-type obturation element 6.

FIG. 6B represents an axial vertical sectional view along ZZ′ of a hoop-type obturation element 6.

FIG. 7A represents a perspective view of the fastening of an actuation element 10 of FIGS. 5A and 5B on a hoop-type obturation element 6 of FIGS. 6A and 6B.

FIG. 7B represents an axial vertical sectional view along ZZ′ of the fastening of an actuation element 10 of FIGS. 5A and 5B on a hoop-type obturation element 6 of FIGS. 6A and 6B.

FIG. 8A represents an axial vertical sectional view along ZZ′ of the detail of the operating mode of the fastening of an actuation element 10 on a hoop-type obturation element 6 of FIGS. 7A and 7B, showing the cooperation of the magnet ring 9 and of the first locking pin 8 without locking.

FIG. 8B represents an axial vertical sectional view along ZZ′ of the detail of the operating mode of the fastening of an actuation element 10 on a hoop-type obturation element 6 of FIGS. 7A and 7B, showing the cooperation of the magnet ring 9 and of the first locking pin 8 in the locking position before locking.

FIG. 9A represents a horizontal sectional view along AA of FIG. 8A.

FIG. 9B represents a horizontal sectional view along AA of FIG. 8B.

FIG. 10 comprises FIGS. 10A-10C which represent vertical sectional views along ZZ′ showing the cooperation of a locking pin 13 of a central hub 6c-6d of a hoop-type obturation element 6 during its locking on a central block 2a of one said support and blocking element 2 by movements of vertical translation and rotation along ZZ′ of said assembly 10, 6 with respect to said central block 2a according to FIGS. 10A-10C respectively.

FIG. 11 comprises FIGS. 11A-11C which represent perspective views showing the cooperation of a locking pin 13 of a central hub 6c-6d of a hoop-type obturation element 6 during its locking on a central block 2a of one said support and blocking element 2 by movements of vertical translation and rotation along ZZ′ of said assembly 10, 6 with respect to said central block 2a according to FIGS. 10A-10C respectively.

### DETAILED DESCRIPTION OF VARIOUS EMBODIMENTS

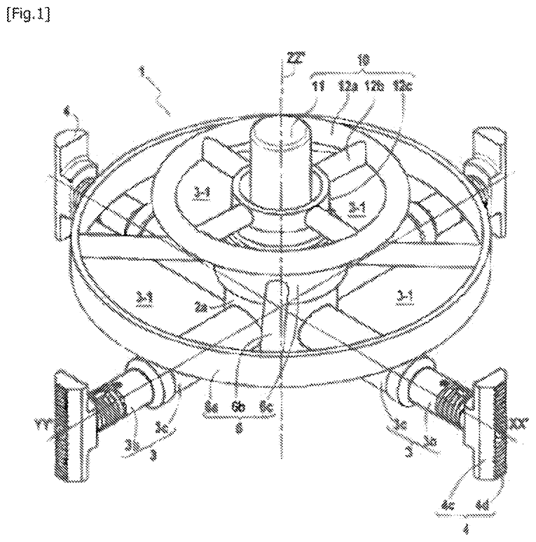

FIGS. 1 to 11 represent one embodiment of a manhole obturation device according to the invention 1 comprising 3 elements which can be fastened to each other by reversible locking means, namely:
a support and blocking element 2 comprising a central block 2a enclosing an angle transmission bevel gear device 5 cooperating with four arms 3 disposed in a cross with their longitudinal axes in directions XX′ and YY′ perpendicularly and radially with respect to the axis ZZ′ of said central block 2a to which they are linked, and
a complementary hoop-type obturation element 6, and
an actuation element 10 comprising (a) an electric geared motor 11 able to actuate a motor shaft Ila along the axis ZZ′ cooperating with the angle transmission device 5 and (b) a handwheel-shaped gripping element 12.

In practice, the fastening of said actuation element 10 is carried out on said obturation element 6, which facilitates the fastening of said obturation element 6 on said central block 2a of said support and blocking element 2 with said handwheel-shaped gripping element 12. Then, said handwheel-shaped gripping element 12 facilitates the set-up of said obturation device according to the invention 1 with its 3 thus assembled elements 2, 3 and 10.

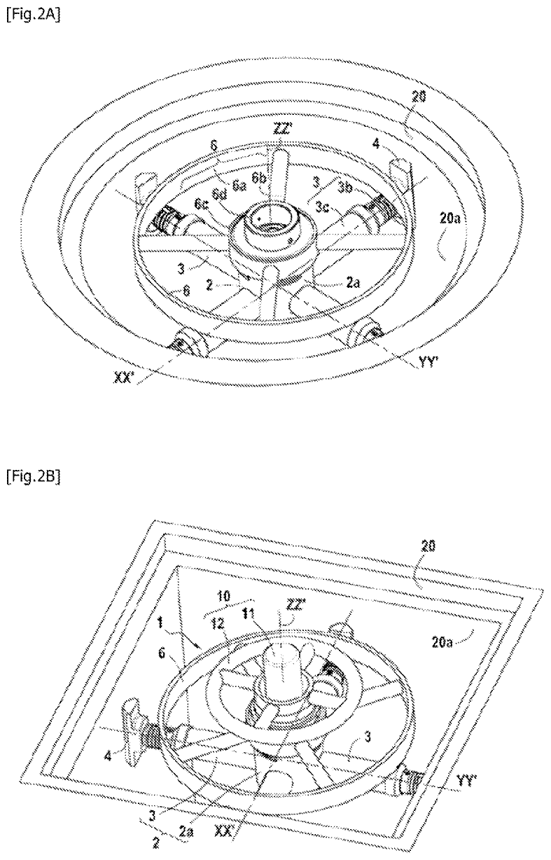

FIGS. 1 and 2B show the obturation device according to the invention 1 with its 3 thus assembled elements 2, 3 and 10. FIGS. 2A and 2B show the obturation device according to the invention 1 in the blocking position with the blocking pads 4 in abutment against the cylindrical wall 20a by extension of the extensible rods 3b disposed in a radial plane XX′, YY′ perpendicular to the longitudinal axis of the central block 2a itself disposed coaxially with the axis ZZ′ of the cylindrical walls 20a and 20b. In FIG. 2A, said actuation element 10 comprising a gripping element 12 and a geared motor 11 has been removed in order to be used for the set-up of another obturation device in another hole 20.

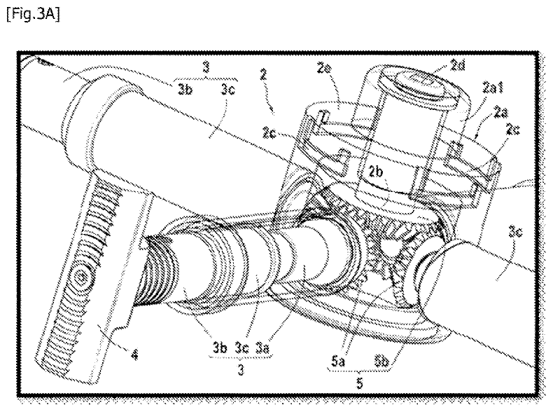

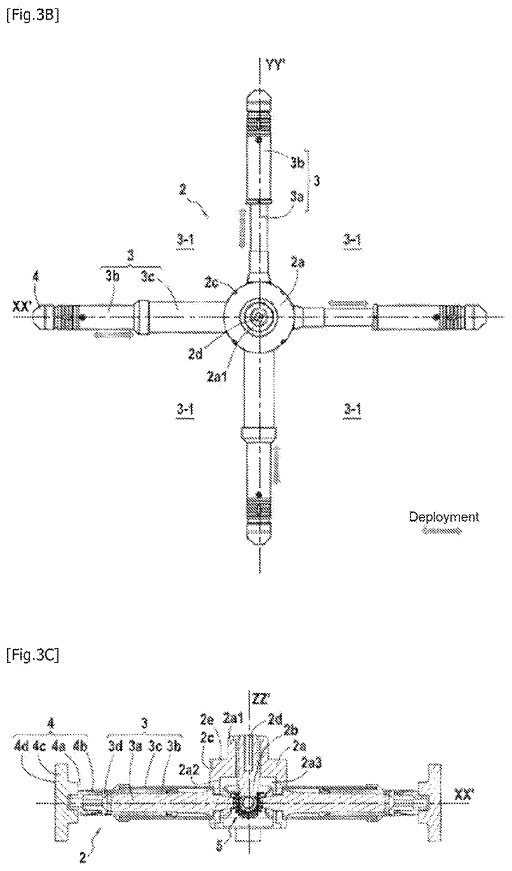

FIGS. 3A-3D show the structure and the operation of the arms 3 mounted on the central block 2a of the support and blocking element 2.

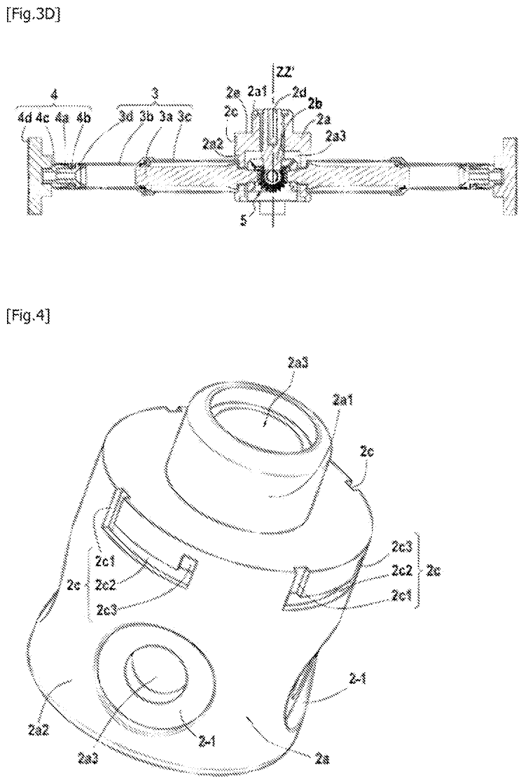

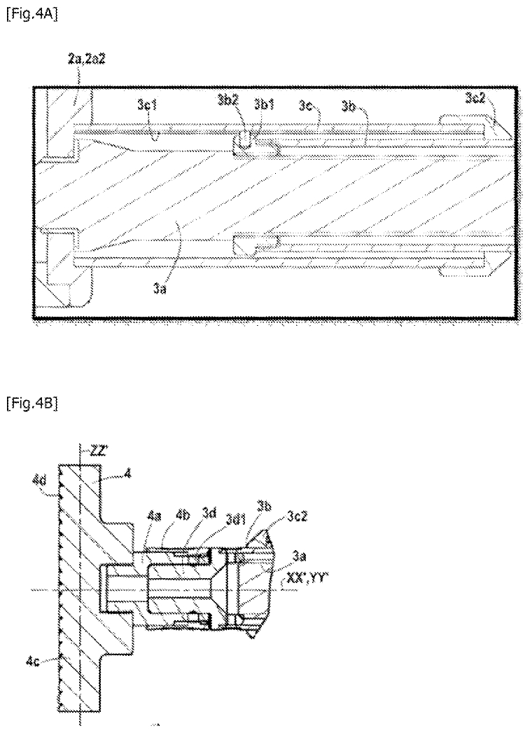

Each arm 3 comprises a drive shaft 3a disposed in one said longitudinal direction in a perpendicular radial plane XX′, YY′ with respect to said longitudinal axis ZZ′ of said central block 2a. Each drive shaft 3a passes at a first end through an orifice 2-1 of the cylindrical wall 2a2 of the block 2a shown in FIG. 4 and ends at said first end by a bevel gear 5a opening out inside an empty space 2a3 delimited by the wall 2a2 of said central block 2a.

As shown in FIG. 3A, said central block 2a comprises an input shaft 2b disposed along the longitudinal axis ZZ′ of said central block 2a and ends at its lower end by a bevel gear 5b inside the empty space 2a3 delimited by the wall 2a2 of said central block 2a. The bevel gear 5b at the end of the input shaft 2b is able to cooperate with the 4 gears 5a at the ends due to the drive shafts to form an angle transmission device 5. The input shaft 2b comprises an axial recess 2d open in the upper portion of the central block 2a able to receive and cooperate with the motor axis 11a of the geared motor 11. Thus, the input shaft 2b can be actuated in rotation on itself with respect to its longitudinal axis ZZ′ when it cooperates with said motor shaft 11a of said actuation element 10 and when the geared motor is electrically actuated. The rotational actuation of said input shaft 2b allows actuating in rotation the meshed bevel pinions 5a and 5b of the angle transmission device 5 so that the rotation on itself along its longitudinal axis ZZ′ of said input shaft 2b simultaneously drives the rotations on themselves of said drive shafts 3a along their axes in their said radial directions XX′, YY′.

As shown in FIGS. 3B-3D and 4A-4B, each arm 3 comprises a drive shaft 3a comprising an external peripheral helical threading 3a1 forming a screw cooperating with a nut 3b1 engaged on the threading 3a1, said nut 3b1 being fastened to the end of a tubular extensible rod 3b able to coaxially cover said drive shaft 3a when the tubular rod 3b is in the retracted position with the nut 3b1 furthest from the central block 2a as shown in FIG. 3C and able to extend beyond the drive shaft 3a when the tubular rod 3b is in the extended position shown in FIG. 3D with the nut 3b1 furthest from the central block 2a.

A guide pin 3b2 on the periphery of the nut 3b1 cooperates with a rectilinear inner slot 3c1 of a guide and protection cylinder 3c coaxially covering said drive shaft 3a and said tubular rod 3b in the retracted position. Thus, said drive shaft 3a is able to cooperate with said extensible tubular rod 3b in coaxial translation by helical link due to the fact that when said drive shaft 3a is driven in rotation on itself along its radial longitudinal axis XX′, YY′, said rotation on itself in either direction of said drive shaft 3a causes the translation of said tubular rod 3b in extension or respectively in retraction in one said radial direction XX′, YY′ due to the fact that the nut 3b1 and therefore said tubular rod 3b which is fastened thereto are prevented from rotating on themselves by the blocking and the guiding of the pin 3b2 in the slot 3c2 thus forcing said coaxial translation of said rod 3b. The tubular rod 3b slides in translation through a terminal ring 3c2 closing the annular space between the guide and protection cylinder 3c and the tubular rod 3b at the end of the guide and protection cylinder 3c.

In FIG. 3B, on the upper and right arms 3, the guide and protection cylinder 3c has not been represented to mount the drive shafts 3a which are otherwise concealed by said cylinders 3c. Said guide and blocking cylinder 3c also acts as a protection for the rod 3b and drive shaft 3a assembly in a helical link.

The free end of the tubular rod 3b furthest from the central block 2a comprises a pad 4 always remaining outside said guide and protection cylinder 3c when the rod 3b is in the maximum retracted position.

FIG. 4B represents one embodiment of a reversible fastening of the pad 4 at the end of the rod 3b using a ball ring system by which a sliding ring on a cylindrical bead 4a of the pad 4 covers and holds a ball 3d1 in a groove of a terminal part 3d at the end of the rod 3b. It suffices to pull the sliding ring 4b on the bead 4a to elastically release the ball 3d1 out of the groove of the terminal part 3d at the end of the cylindrical rod 3b in order to be able to separate the pad 4 from the rod 3b. This reversible locking is quick and ergonomic. Thus, it is possible to change the pad 4 so that the latter has a shape adapted to the surface of the cylindrical side wall 20a, 20b of the passage 20 against which it must be applied in abutment.

The pad 4 comprises an end part 4c fastened to the bead 4a which ensures the link to the end of the arm 3, preferably an end part 4c made of rigid elastomer material. The end part 4c has a longitudinal shape in the direction ZZ′ of the axis of the passage or hole 20. The end part 4c comprises a contact surface 4d with the cylindrical wall 20a, 20b of the passage 20 which has a cross-sectional contour in the plane XX′, YY′ which follows the cross-sectional contour of said cylindrical wall 20a, 20b in the plane XX′, YY′.

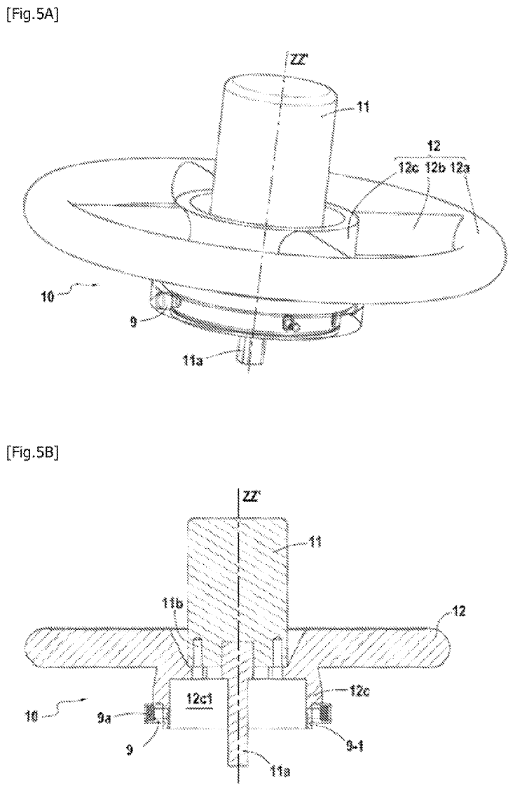

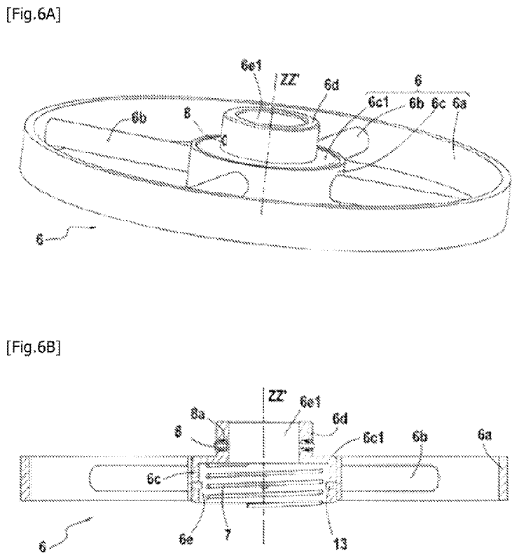

FIGS. 5A and 5B represent an actuation element 10 with geared motor 11 and a handwheel-shaped gripping element 12 and a magnet ring 9 on the underside intended for the reversible locking of said actuation element on a hoop-type obturation element 6 represented in FIG. 6A-6B.

The geared motor 11 is able to actuate in rotation place along the axis ZZ′ of a passage 20 with a cylindrical wall 2a, 20b. A gripping element 12 comprises a circular handwheel 12a and a first coaxial central hub 12c linked to each other by first linking elements by forming first spokes 12b disposed in a cross (at 90°). The tubular wall of the first central hub 12c is surmounted by said geared motor which is fastened thereto by studs 11b and delimits a first central cylindrical recess 12c1 traversed by said motor shaft 11a disposed coaxially along the axis ZZ′. On the underside of the tubular wall of the first central hub 12c is disposed coaxially a ring 9 which is fastened thereto by a circular fastener 9-1 coaxial along ZZ′ so that the ring 9 is able to be driven manually in relative rotation with respect to said first central hub 12c to achieve the reversible locking of said actuation element on a hoop-type obturation element 6 represented in FIG. 6A-6B while maintaining said ring secured to the underside of the tubular wall of said first central hub 12c.

The ring 9 comprises two magnets 9a in two diametrically opposed first empty housings 9b.

FIGS. 6A-6B represent a hoop-type obturation element 6 comprising:
a second central hub 6c of axis ZZ′ and a peripheral circular rim 6a of axis ZZ′ when the element is in place coaxially on the device of the invention 1 in the passage 20, and
4 second spokes 6b disposed in a cross (at 90°) in a radial plane XX′, YY′ ensuring the link with respect to a second central hub 6c of axis ZZ′ and a wheel rim 6a.

The hoop 6 is intended to be positioned above the support and blocking element 2 with the second spokes 6b disposed from the 4 arms 3 in the directions of the bisectors of the empty spaces 3-1 between two adjacent arms 3. The second spokes 6b have a length such that the rim 6a arrives at the level of the end 3c2 of the protection cylinder 3c. In practice, the hoop 6 and the protection cylinders 3c of the arms 3 are dimensioned such that the arms 3 being in maximum extension with the pads 4 in abutment on the lateral surface 20a, 20b, the rim 6a arrives approximately to the half the length of said arms 3, that is to say the length of the protection cylinders 3c represents approximately half the length of said bars 3 in maximum extension.

The second central hub 6c is of tubular shape delimiting a coaxial cylindrical internal recess 6e of axis ZZ′. The second central hub 6c is surmounted by a coaxial upper portion 6d of cylindrical tubular shape forming a shoulder 6c1 at the junction between the second central hub 6c and its upper portion 6d. The upper portion 6d delimits an internal recess 6e1 of smaller diameter than the recess 6e and communicating therewith.

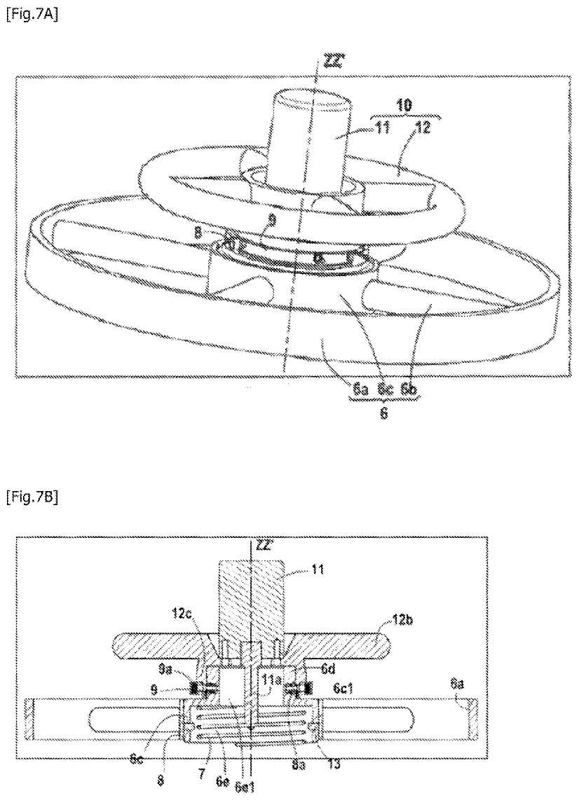

The shoulder 6c1 is able to support the circular fastener 9-1 and the ring 9 on the underside of the tubular wall of the first central hub 12c when said actuation element 10 comprising the geared motor 11 and the handwheel 12 are assembled on the hoop 6 by coaxially threading the ring 9 and the tubular wall of the first central hub 12c on the upper portion 6d surmounting the second central hub 6b as shown in FIGS. 7A-7B.

The tubular wall of the upper portion 6d surmounting the second central hub 6c comprises at its lower end close to the shoulder 6c1, two diametrically opposed second hollow housings 8b enclosing respectively two first locking pins 8.

A second coaxial spring 7 which serves for the reversible locking of the hoop 6 on the support and blocking element 2 is disposed within the recess 6e delimited by the tubular wall of the first central hub 12c. The tubular wall of the first central hub 12c has four second locking pins protruding on its inner face protruding towards the central recess 6e. The second spring 7 and the second locking pins are able to cooperate with outer slots 2c on the periphery of the walls of the central block 2a of the support and blocking element 2 in order to achieve a reversible locking of the hoop 6 on the central block 2a.

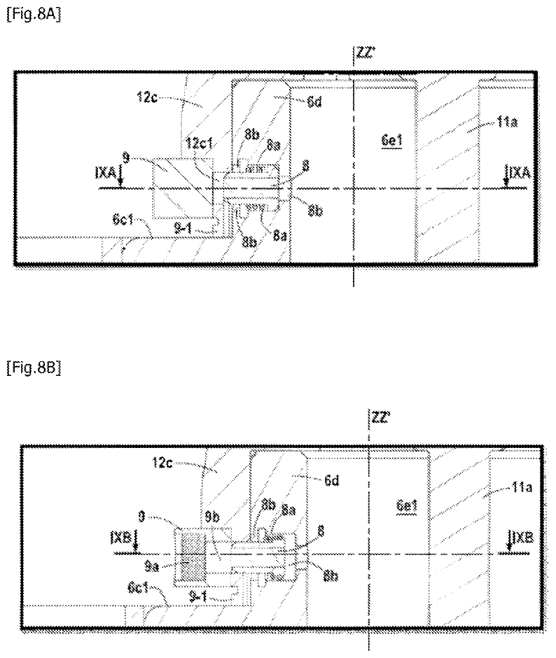

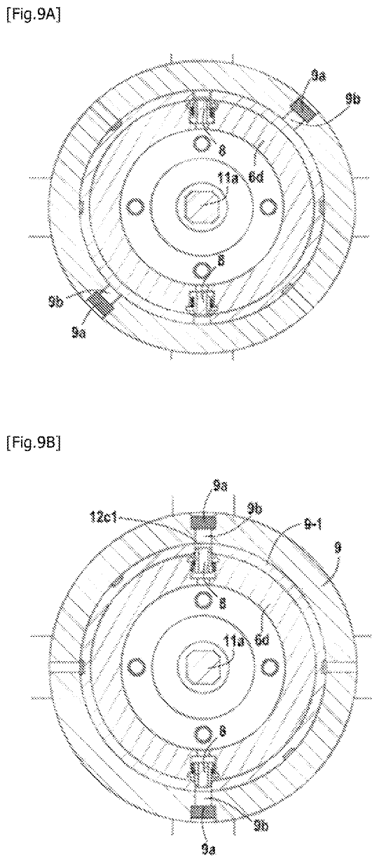

In FIGS. 8A-9A, the ring 9 is in a position of relative with respect to the second central hub 6c and its upper portion 6d such that the two first locking pins 8 are held in the hollow housings 8b by compressing first springs 8a due to the fact that the first hollow housings 9b are not positioned opposite the second hollow housings 8b.

In FIGS. 8B-9B, the ring 9 is in a position of relative rotation with respect to the second central hub 6c and its upper portion 6d such that the two first hollow housings 9b are positioned opposite the second hollow housings 8b. Thus, the first two metal locking pins 8 are ready to be attracted by the magnets 9a and leave the second hollow housings 8b by extension of the first springs 8a due to the fact that the first hollow housings 9b are not positioned opposite the second hollow housings 8b. A new rotation of the ring 9 will cause the entry of the first two metal locking pins 8 into the second hollow housings 8b and the compression of the first springs 8a.

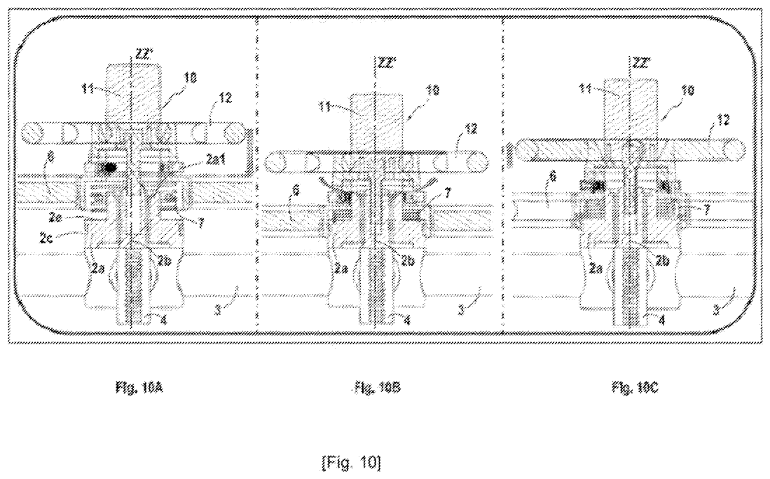

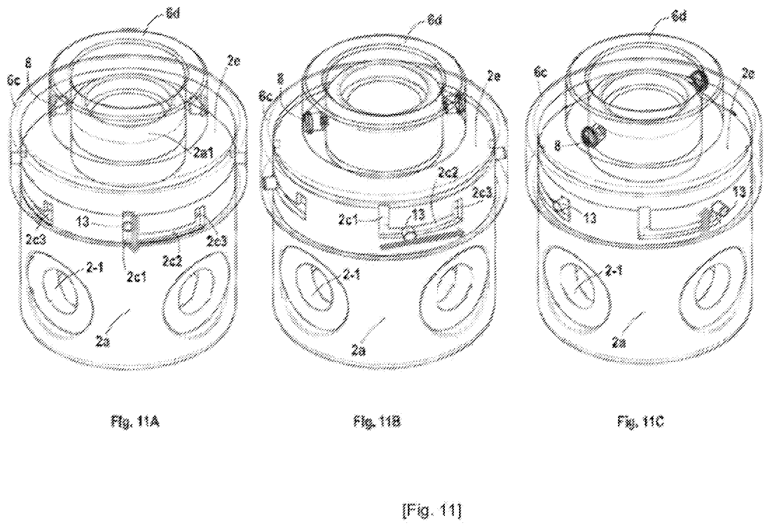

FIGS. 10A-11A, 10B-11B, 10C-11C represent the operation of the second reversible locking means allowing the reversible fastening of the hoop 6 on the central block 2a of said support and blocking element 2, by movements of relative axial rotation and translation of the assembly of said actuation element 10 fastened to said obturation element 6 with respect to said support and fastening element 2, along and respectively about said longitudinal axis ZZ′.

FIG. 4 represents the outer wall of said central block 2a comprising four slots 2c each comprising a first vertical portion 2c1 along the longitudinal direction (ZZ′) of said block, a second circular-arc portion 2c2 on the periphery of said cylindrical block 2a corresponding for example to a 45° rotation, and a third vertical portion 2c3, said second circular-arc portion 2c2 forming the junction of the lower ends of said first and third vertical portions 2c1, 2c3, said first vertical portion 2c1 being open at its upper end and said third vertical portion 2c3 being closed at its upper end.

FIG. 10A shows a first downward vertical translational movement of the assembly of said actuation element 10 fastened to said obturation element 6 with respect to said central block 2a and coaxially therewith along its longitudinal axis ZZ, by engaging the motor shaft 11a in an upper axial orifice 2d of the input shaft 2b of said central block 2a, before the second central hub 6c of the hoop 6 abuts on the shoulder 2e of the central block 2a, the second spring 7 being in extension.

FIG. 11A shows the sequence of the first downward vertical translational movement of the assembly of said actuation element 10 fastened to said obturation element 6 with respect to said central block 2a and coaxially therewith along its longitudinal axis ZZ′, said second blocking pin 13 of the hoop 6 being engaged and guided in translation in said first vertical slot portion 2c1. This first movement continues until the second central hub 6c of the hoop 6 abuts on the shoulder 2e of the central block 2a and the pin 13 arrives at the lower end of said first vertical slot portion 2c1 by compressing said second spring 7 in doing so as shown in FIG. 10B. This first downward vertical translational movement is facilitated by the gripping and the axial positioning of the assembly of said actuation element 10 fastened to said obturation element 6 with respect to said central block 2a, using the handwheel 12.

At this stage, as shown in FIG. 11B, by turning the handwheel 12, a second rotational movement of the assembly of said actuation element 10 fastened to said obturation element 6 with respect to said central block 2a is carried out, said second blocking pin 13 thus being guided in rotation in said second circular slot portion 2c2 up to the lower end of said third vertical slot portion 2c3, while keeping said second spring 7 compressed.

FIGS. 10C and 11C show a third upward vertical translational movement of the assembly of said actuation element 10 fastened to said obturation element 6 with respect to said central block 2a and coaxially therewith along its longitudinal axis ZZ′, said second blocking pin 13 thus being guided in translation in said third vertical slot portion 2c3 up to its upper end due to the extension of said second spring 7.

The obturation device according to the invention is an articulated system of 4 arms that allows blocking the passage of a manhole. The arm extension system has been described as being preferably an electromechanical system operating via a screw-nut system to make a helical link causing the deployment of the rod accompanied by a gear torque multiplier to provide the required force with bevel gears to redirect the axes of rotation. The input shaft 2b is rotated via the motor axis 11a and the bevel gear system 5 allows the redirection of the main rotation on the 4 secondary shafts 3a which drive the helical link (screw-nut). Thus, also thanks to the blocking of the rotation of the output rod 3b via a slot 3c1 in the guide 3c, the system is deployed. It is under stress during the contact of the pads 4 with the walls of the manhole 20.

However, they can be substituted with hydraulic or pneumatic jacks, thus providing a slide link or sliding pivot link rather than a helical link, said jacks being coupled on a hydraulic or pneumatic fluid supply. In this case, manual pre-adjustment is required to reduce the used volume of fluid.

The obturation device according to the invention is adaptable to all manhole geometries and dimensions thanks to a stress made on the walls of the hole by activation of the arm extension system.

The obturation device according to the invention is mainly used for prevention in case of flooding (the system can be sealed), prevention during work, or obturation of possible exits in the event of an attack. In these multiple cases, the obturation device according to the invention allows preventing a person from falling through the manhole or prohibiting the voluntary passage of an individual.

A method for setting up an obturation device according to the invention 1 in order to transversely obstruct a passage 20 delimited by a cylindrical side wall 20a, 20b, comprises the steps of:
1) fastening on said obturation element 6, one said actuation element 10 comprising a handwheel-shaped gripping element 12, then
2) fastening on said central block 2a of said support and blocking element 2, the assembly of said actuation element 10 assembled with said obturation element 6, and
3) positioning, using the handwheel-shaped gripping element 12, the device according to the invention in said passage 20 with the extensible rods 3b of said arms in the retracted position, said arms being disposed in a perpendicular radial plane XX′, YY′ with respect to said longitudinal axis ZZ′ of said central block 2a itself disposed coaxially with the axis of said passage 20, and
4) actuating the geared motor 11 to actuate in extension said four extensible rods 3b simultaneously said arms 3 in extension to block said pads 4 in abutment against the cylindrical wall 20a, 20ab of said passage as shown in FIG. 2A-2B, and
5) removing said removable actuation element 10 to let in the passage only the assembly of said support and blocking element 2 and said obturation element 6 as shown in FIG. 2A.

The obturation hoop 6 is locked via a simple mechanical action made by the user on the handwheel 12. The locking pins 13 must therefore be aligned with the slots 2c1 present on the central block 2a. Then, the assembly is depressed, and a 45° rotation is exerted in the slot 2c2. Finally, the handwheel 12 is loosened, which allows the assembly to move up thanks to the spring 7. The locking pins 12 will thus be blocked in the slot 2c3. The unlocking is simple: the actions listed in reverse order must be made.

In step 5), the separation of the handwheel 12 is exerted by a simple 30° rotation of the magnet ring 9.

1.-14. (canceled)

15. A removable obturation device for transversely obstructing a passage delimited by a cylindrical side wall wherein it comprises:
a) a support and blocking element comprising a central block comprising a longitudinal axis intended to be positioned in the longitudinal axis of said side wall of said passage, supporting a plurality of arms disposed perpendicularly in a radial position with respect to said longitudinal axis, the different arms being disposed symmetrically with respect to said longitudinal axis;
each arm comprising an extensible rod comprising at its free end a pad, fastened in a reversible manner to the end of said extensible rod, able to be blocked in abutment against one said side wall by extension of said extensible rod, and
b) at least one complementary obturation element extending in a transverse plane perpendicular to said longitudinal axis of said passage, at least partly in or opposite the space between said arms so as to prevent an individual from falling through said passage, said obstruction element being removably fastened to said support and blocking element;
c) a removable actuation element able to cooperate with said central block to actuate in extension or retraction said extensible rods of said arms simultaneously, said actuation element comprising first reversible fastening means on said support and blocking element, at said central block.

16. The device according to claim 15, wherein
said actuation element comprises a geared motor able to actuate in rotation on itself along its longitudinal axis a shaft called motor shaft, and
said support and blocking element comprises:
a1) said arms each comprising one said drive shaft disposed in one said longitudinal direction in a perpendicular radial plane with respect to said longitudinal axis of said central block, each said drive shaft being able to be driven in rotation on itself along its radial longitudinal axis and able to cooperate with one said extensible rod in coaxial translation by helical link such that said rotation on itself in either direction of said drive shaft causes the translation of said extensible rod in extension or respectively in retraction in one said radial direction, and
a2) one said central block comprising a shaft called input shaft disposed along the longitudinal axis of said central block and able to be actuated in rotation on itself with respect to its longitudinal axis when it cooperates with said motor shaft of said actuation element, and an angle transmission device comprising bevel gears able to cooperate with each other at the ends of said input shaft and said drive shafts so that the rotation on itself along its longitudinal axis of said input shaft simultaneously causes the rotations on themselves of said drive shafts along their axes in their said radial directions.

17. The device according to claim 16, wherein said helical link is of the screw-nut type, said drive shaft comprising an external helical threading forming a screw cooperating with a tubular rod at least one end portion of which forms a nut engaged on the threading of the threaded screw formed by said drive shaft, said nut being prevented from following said rotation of said drive shaft and said tubular rod being guided in said translation by a guide pin of said nut due to the fact that said guide pin cooperates with a rectilinear inner slot of a guide and protection cylinder inside which said drive shaft and one end portion at least of said tubular rod extend coaxially, the free end of the rod comprising said pad always remaining outside said guide and protection cylinder.

18. The device according to claim 15, wherein it comprises a single obturation element extending above said arms, able to be removably fastened to said support and blocking element at said central block.

19. The device according to claim 18, wherein said obturation element comprises a hoop linked to a central hub by spokes, said central hub of said hoop being able to be removably fastened to said support and blocking element around said central block so that said spokes of the hoop extend between said arms, along the bisectors of the angles between said arms.

20. The device according to claim 15, wherein said support and blocking element comprises four said arms disposed in a cross at 90° around the central block.

21. The device according to claim 15, wherein said actuation element comprises a handwheel-shaped gripping element around said geared motor to which it is fastened.

22. The device according to claim 15, wherein said actuation element comprises first reversible fastening means on said obturation element, at a central hub of said hoop-shaped obturation element, the latter comprising second reversible fastening means on said support and blocking element, at said central block.

23. The device according to claim 22, wherein said actuation element comprises a handwheel-shaped gripping element around said geared motor to which it is fastened, said handwheel comprising first reversible locking means allowing the blocking of the reversible fastening of said actuation element on said obturation element, by a movement of relative axial rotation about said longitudinal axis of a magnet ring rotating with respect to said handwheel and on the underside of said handwheel, at least one magnet of said ring being able to cooperate with respectively at least a first metal elastic locking pin in a hole of said obturation element, said first metal locking pin being able to leave said hole attracted against said magnet, by a first spring, when the positioning of said actuation element with respect to said obturation element on and the rotation of said ring places said magnet opposite the first elastic locking pin of said obturation element, opposite a first elastic locking pin in a hole at a central hub of said hoop-shaped obturation element.

24. The device according to claim 23, wherein said obturation element comprises second reversible locking means allowing a blocking of the reversible fastening on said support and blocking element of the assembly of said actuation element fastened to said obturation element, by movements of relative axial rotation and translation with respect to said support and fastening element of the assembly of said actuation element fastened to said obturation element, along and respectively about said longitudinal axis.

25. The device according to claim 24, wherein said hoop-shaped obturation element and said second reversible locking means comprise:
at a central hub of said obturation element, at least a second locking pin and a second spring in a cylindrical recess within said central means, and
on the outer wall of said central block, at least one locking slot comprising a first vertical portion along the longitudinal direction of said block, a second circular-arc portion on the periphery of said block and a third vertical portion, said second circular-arc portion forming the junction of the lower ends of said first and third vertical portions, said first vertical portion being open at its upper end and said third vertical portion being closed at its upper end,
so that said second reversible locking means are able to be actuated in locking by:
a first downward vertical translational movement of the assembly of said actuation element fastened to said obturation element with respect to said central block and coaxially therewith along its longitudinal axis, said second locking pin thus being able to be guided in translation in said first vertical slot portion up to its lower end by compressing said second spring in doing so,
a second rotational movement of the assembly of said actuation element fastened to said obturation element with respect to said central block, said second locking pin thus being able to be guided in rotation in said second circular slot portion up to the lower end of said third vertical slot portion, keeping said second spring compressed, and
a third upward vertical translational movement of the assembly of said actuation element fastened to said obturation element with respect to said central block and coaxially therewith along its longitudinal axis, said second locking pin thus being able to be guided in translation in said third vertical slot portion up to its upper end due to the extension of said second spring.

26. A method for setting up an obturation device according to claim 15 in order to transversely obstruct a passage delimited by a cylindrical side wall, wherein it comprises the stages of:
a) positioning the device according to the invention in said passage with the extensible rods of said arms in the retracted position, said arms being disposed in a perpendicular radial plane with respect to said longitudinal axis of said central block itself disposed coaxially with the axis of said passage, and
b) actuating, by means of one said actuation element, said arms to block said pads in abutment against the cylindrical wall of said passage by extension of the said extensible rods, said actuation element cooperating with said central block to actuate in extension said extensible rods of said arms simultaneously.

27. The method for setting up an obturation device according to claim 26, wherein it comprises the steps of:
a) positioning said device according to the invention in said passage with the extensible rod of said arms in the retracted position, using a handwheel-shaped gripping element fastened around a geared motor of said removable actuation element, and
b) actuating said arms to block said pads in abutment against the cylindrical wall of said passage by extension of said extensible rods using said geared motor of said actuation element, and
c) removing said removable actuation element to let in the passage only the assembly of said support and blocking element and said obturation element.

28. A method for setting up an obturation device according to claim 26, wherein it comprises the preliminary steps of:
a1) fastening on said obturation element one said actuation element comprising a handwheel-shaped gripping element, then
a2) fastening the assembly of said actuation element assembled with said obturation element on said central block of said support and blocking element.
